(19) United States
(12) Patent Application Publication
(10) Pub. No.: US 2023/0127603 A1
(43) Pub. Date: Apr. 27, 2023

(54) Grit Suppression Ball Valve Assembly for Blast Pot

(71) Applicant: Phuong Taylor Nguyen, Richmond, TX (US)

(72) Inventor: Phoung Taylor Nguyen, Richmond, TX (US)

(21) Appl. No.: 15/929,857

(22) Filed: May 26, 2020

(51) Int. Cl. B24C 7/00; F16K 17/12

(52) U.S. Cl. CPC B24C 7/0061; F16K 17/12

(57) ABSTRACT

A ball valve with a typical pop-up head has a central vertical threaded insert for receiving a stem. A grit suppression sleeve is placed on the stem concentric with the stem. The grit suppression sleeve is generally a spool with a center hole fitting on the stem. The inside diameter of the stem is larger than the outside diameter of the suppression sleeve, permitting the sleeve to move freely on the stem and providing a controlled air way that will not carry grit, suppressing the grit that previously was exhausted through the main ball valve exit port.

### BACKGROUND OF THE INVENTION

Field of the Invention: This invention is generally related to control valves for the media blasting industry and is specifically directed to a pop-up ball valve that is used when de-pressurizing the blast pot.

Discussion of the Prior Art: Abrasive blaster systems are well known. Typical abrasive blasters include the 1.5, 3.5, 6.5, 8, 10 and 20 cubic feet abrasive blasters manufactured and sold by Axxiom Manufacturing, Inc., Fresno, Texas, USA and sold under the brand name SCHMIDT. These systems include a pressure vessel or tank having two components: a pressure section and an abrasive section. In order for the system to operate properly, the two sections must be balanced. A pop-up valve in the pressure inlet pipe permits the system to automatically react to pressure changes by opening and closing a passageway between the abrasive chamber and the pressure chamber.

During blowdown, when the system is depressurized, the pop-up valve closes the pressure inlet. This is primarily to prevent stray abrasive particles from flowing back into the pressure system. However, it has been determined that this is an inefficient method for closing the pressure system in order to minimize backflow of stray abrasive particles. Therefore, there is a need to further reduce the potential backflow of particles during blowdown and depressurization of the system.

### SUMMARY OF THE INVENTION

The subject invention is directed to a pop-up ball valve for use in connection with a blast pot such as that used in the media blasting industry for controlling the release of air when depressurizing the blast pot during various downtimes. The pop-up ball valve includes several exit paths, permitting control of the airflow through the valve and the redirection of the grit media by generating a back flow using the released air to drive the grit away from the primary flow of air out of the blast pot during shutdown.

This is accomplished by configuring the ball valve with a typical pop-up head having a central vertical threaded insert for receiving a stem. A grit suppression sleeve is placed on the stem concentric with the stem. The grit suppression sleeve is generally a spool with a center hole fitting on the stem. The inside diameter of the stem is larger than the outside diameter of the suppression sleeve, permitting the sleeve to move freely on the stem and providing a controlled air way that will not carry grit, suppressing the grit that previously was exhausted through the main ball valve exit port.

A grit suppression sealing seat is mounted on the vertical open-ended air inlet pipe to suppress grit from entering the open ended air inlet pipe

The subject invention is useful in pressurizing and depressurizing a blast pot while controlling the release of stray grit generally released during operations that include opening and closing the ball valve.

### BRIEF DESCRIPTION OF THE DRAWINGS

FIG. 1 illustrates the complete pop-up assembly including the air supply lines and valves and the deadman switch.

FIG. 2 is a view looking in the same direction as FIG. 1, but emphasizing the closed position of the pop-up valve during pressurizing the blast pot.

FIG. 3 is a view looking in the same direction as FIG. 1, showing the blast pot equalized, permitting the grit suppression seal to fall down the stem sleeve and be seated on the vertical air inlet pipe.

FIGS. 4, 4A, 4B and 4C shows various positions of the pop-up valve system during specific operations.

FIG. 5 is an enlarged exploded view of the pop-up valve assembly.

FIG. 6 is similar to FIG. 1 and shows the settings of the various components and valves depressurizing using a pneumatic system.

FIG. 7 is similar to FIG. 6 and shows the settings of the various components and valves during a pressurizing action, also using a pneumatic system.

### DETAILED DESCRIPTION

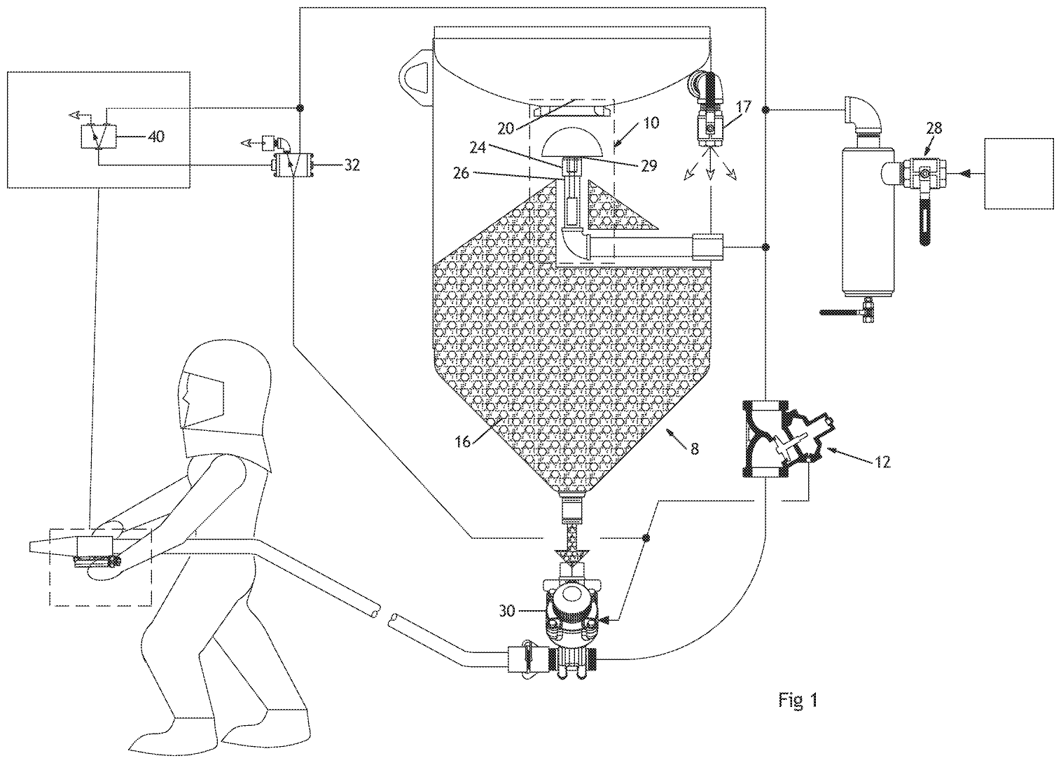

Turning to FIG. 1, a typical blast pot 8 is shown with the novel pop-up ball valve 10 installed. A primary air valve 12 controls the air supply circuit and is in communication with a compressed, pressurized air source 14, providing the system with pressurized air for controlling the valve system of the assembly, including the novel pop-up valve 10.

In FIG. 1, the air inlet valve 12 is closed, which means the system is shut down whether or not there is any abrasive 16 in the blast pot 8. Since the ball valve is open, the air in the blast pot will escape through the open port in the blast pot top and the pressure will equalize with the ambient pressure outside the blast pot. The sleeve 29 is also free to move to its seat 24 at the upper, open end of the vertical pipe 26. This blocks stray media from entering the air system during blowdown mode. The air supply valve 28 is also closed as well as the media valve 30 and the control valve 32. In this mode the pressurized air has been released through the open valve 10 in what is commonly called blowdown (i.e., reducing the pressure to ambient level).

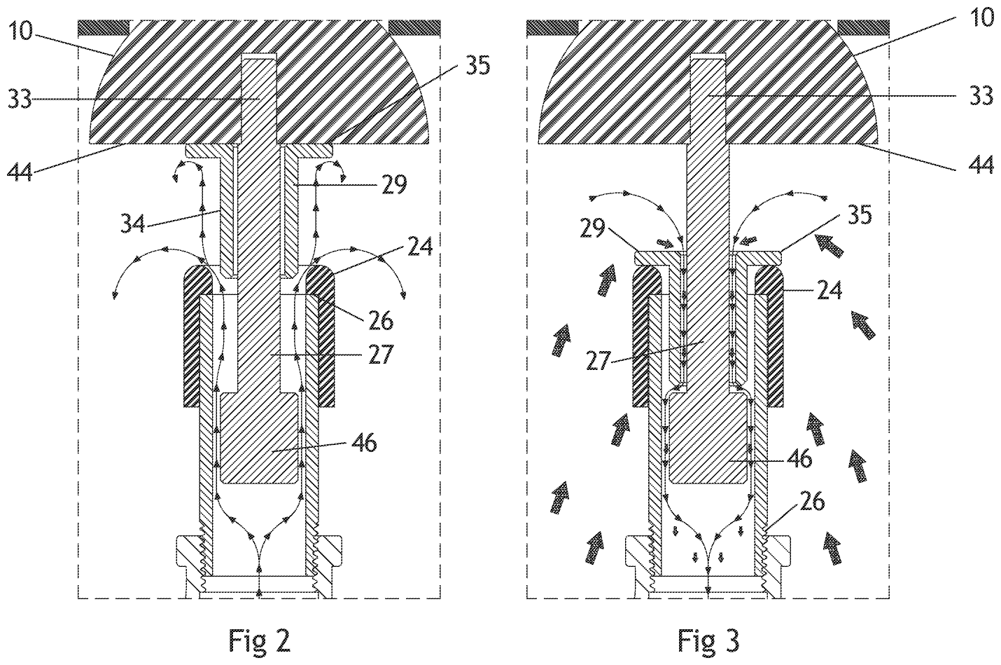

FIGS. 2 and 3 show the air flowing during repressurization of blast pot 8. The ball valve 10 is pushed up by the increasing pressure to seal the open port in the top of the blast pot. When increasing pressure in the blast pot, the sleeve 29 stays against the upper open end of the vertical pipe 26. The inside diameter 34 of sleeve 29 is larger than the outer diameter 36 of pipe 26. This difference allows air to flow into and around and out of the pipe system, enhancing the pressurizing operation while being too tight to permit particle flow into the system. The lower end 40 of the stem 27 is enlarged and engages the inner wall of pipe 26 for stability and also provides a narrow passage for air, but too tight for abrasive particles. The upper face 35 of the sleeve 29 presses against the lower face 44 of the ball valve, sealing the interior passage between the pipe 26 and sleeve 29.

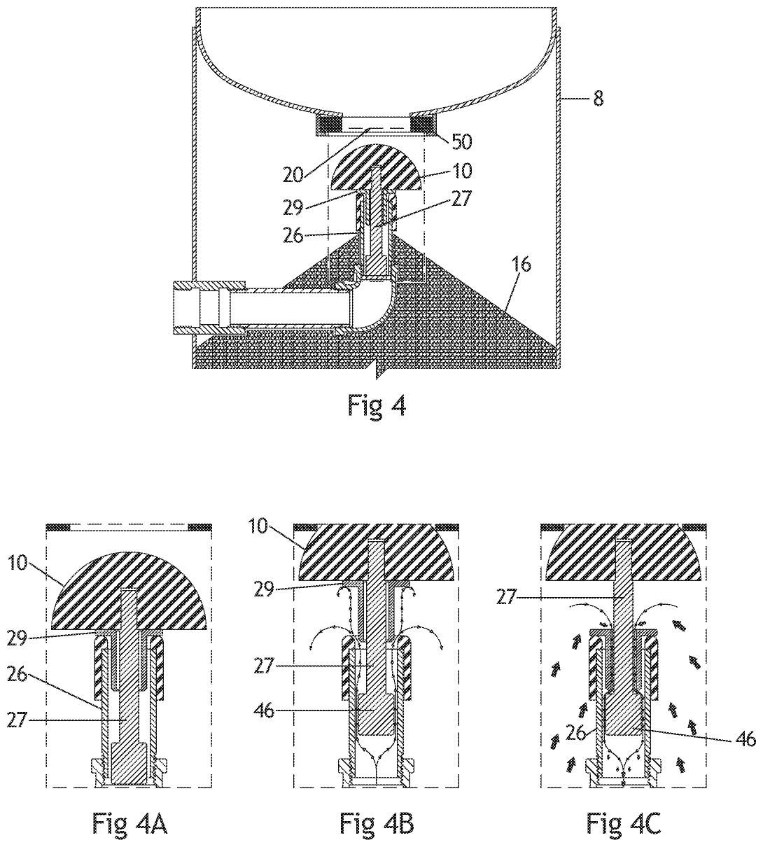

FIG. 4 is similar to FIGS. 4, 4A, 4B, and 4C are fragmentary views looking in the same direction as FIGS. 1 and 2. FIG. 4 highlights the seal 50 surrounding port 20 for providing a tight seal between the bottom blast pipe and the ball valve 10. FIG. 4A shows the blast pot 8 down to its lowest position relative to the open end of vertical pipe 26. The upper end of the pipe 26 also defines a seat the sleeve 29 when the ball valve, stem and sleeve assembly are fully retracted toward pipe 16.

The stem 27 is retracted into the vertical pipe 26. This upper inside edge of sleeve 29 is positioned against the upper end defining a seat 24 for the sleeve. This occurs when the pressure in the blast pot 10 is equal ambient pressure.

FIG. 4B shows the system is pressurized with the ball valve 10 sealed against gasket 50 and the sleeve 29 held on the pipe seat 24. FIG. 4C shows the pop-up valve assembly in position when depressurizing the blast pot and the pressure has equalized.

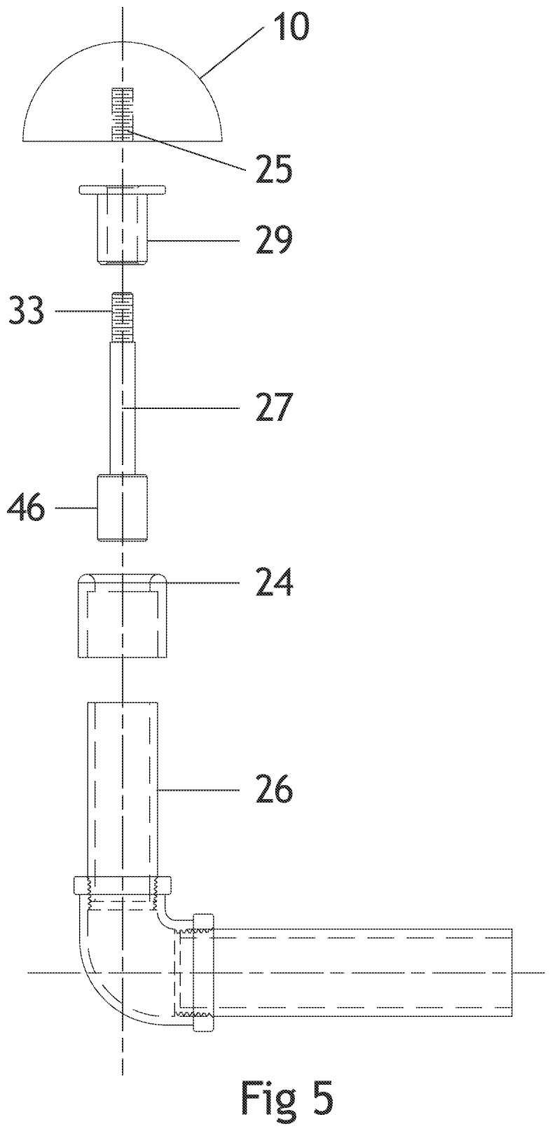

FIG. 5 is an enlarged, exploded assembly of the ball valve assembly of the current invention system. The lower end of the stem 27 has an enlarged base 41. This provides a minimal pathway for air flow around perimeter of the stem 27 and the surrounding pipe 26. The pathway is sufficient for air flow but is too tight to receive grit particles. The upper end of the stem 27 includes a threaded tip 33 which is adapted to be received by the tapped recess 25 in the ball valve 10.

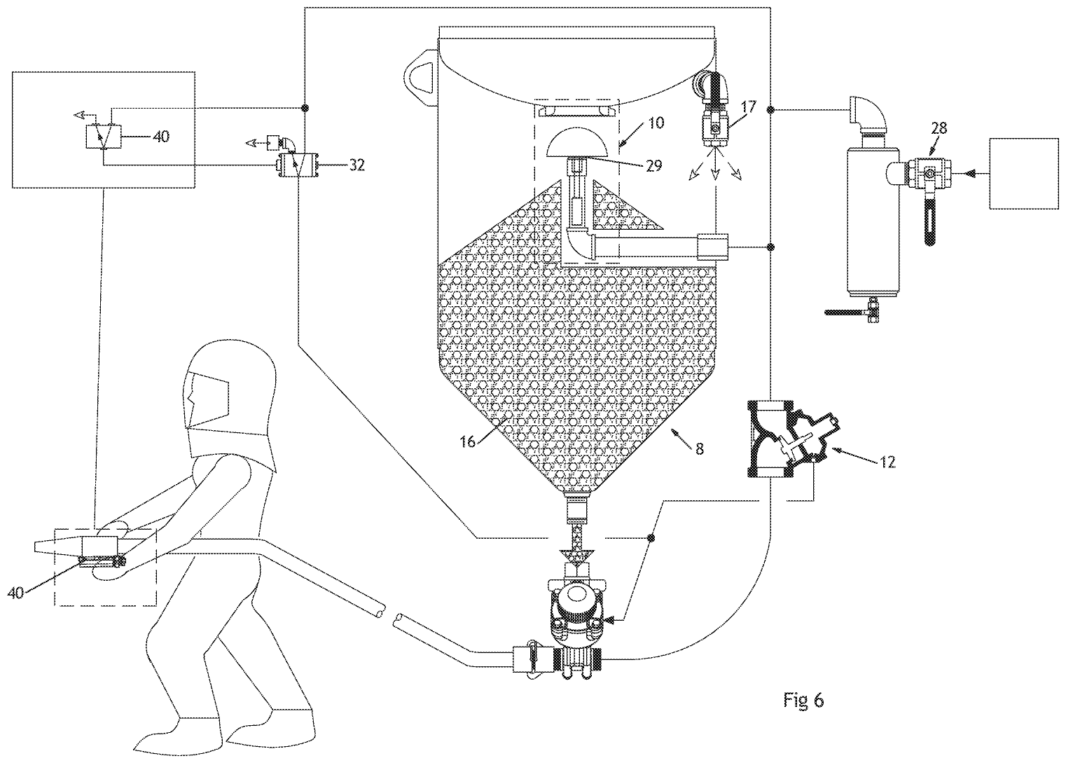

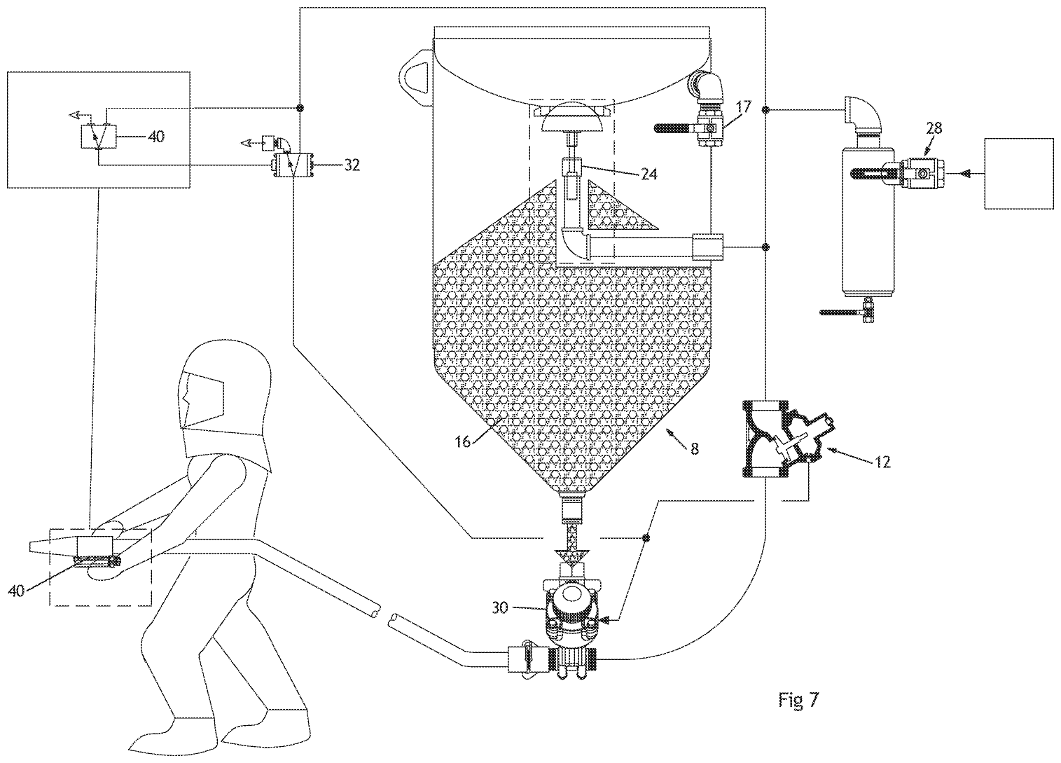

FIGS. 6 and 7 are identical with the exception of the position of the deadman switch 40. In FIG. 6, the deadman switch 40 is closed or in operating mode. The controlled circuit this configuration supports: the blowdown valve 17 (open), the air supply valve 28, the media valve 30 (closed), a Pop-up Mode air valve 12 (closed), the pop-up 10 open (down), sleeve 29 (down), control valve 32 (closed), sleeve 29 (down).

In Fig.7 the blowdown valve 17 is closed. The remaining valves are positioned to support a pop-up operation with air inlet valve 10 down and open, air supply valve 28 (open), the deadman switch 40 (closed), pop-up valve 10 (down, open), sleeve 29 (up), control valve 32 (closed), air valve 12 (closed), and media valve 30 (closed).

While certain features and embodiments have been disclosed herein, it should be understood that the invention as claimed covers all systems within the scope and spirit of the following claims.

What is claimed is:

1. A pop-up ball valve assembly for use in connection with a blast pot having a generally closed top with an open/closing port on the top of the pot and a media inlet port provided by at the bottom of the pop-up ball being of the type having a generally spherical shape with a flat portion at the bottom of the pot and a substantially vertical stem defined by a substantially vertical open ended pipe, coupled for supporting the pop-up ball valve and permitting it to slide on the stem and engage and seal the port when the pot is under pressure and to drop and disengage the port when the pot is depressurized, the pop-up valve assembly comprising:
a. the pop-up ball having a tapped recess on the bottom face,
b. the elongated stem having an enlarged lower end and a threaded upper end, the threaded upper end mated with the tapped recess in the pop-up ball for receiving the threaded upper end of the stem,
c. a sleeve on the stem and freely movable along the entire exposed length of the pipe and able to engage the bottom wall of the ball valve at one end and be seated on the upper end of the vertical pipe.

2. The pop-up valve assembly of claim 1, the pot having a gasket for providing a seal between the ball valve and the sleeve when the sleeve is moved into contact with the ball, wherein the sleeve is responsive to the repressurizing of the pot to move upward with the general flow of air during repressurization and move down to the seat during depressurization.

3. The pop-up valve assembly of claim 1, wherein a lower end of the pot includes a pipe extending through wall and terminating in a vertical extension inside the pot, the pipe generally projecting upward and terminating at an open upper end, the pop-up assembly further comprising a sleeve having an inside diameter which is larger than the pipe outside diameter, permitting the sleeve to pass over the pipe, the sleeve further including a circumferential ring about its top end adapted to be engaged by the open upper end, the upper open end of the pipe serving as a seat for the sleeve.

4. The pop-up valve assembly of claim 2, further comprising an enlarged section of the stem, sized to fit in the open ended vertical pipe, the outside diameter of the pipe sufficient to provide stability to the assembly and including air pathways which are sufficiently sized to let pressurizing air pass through but too small to permit abrasive media particles.
